(19) United States
(12) Patent Application Publication
(10) Pub. No.: US 2019/0137831 A1
(43) Pub. Date: May 9, 2019

(54) PIXEL STRUCTURE

(71) Applicant: Chunghwa Picture Tubes, LTD., Taoyuan City (TW)

(72) Inventor: Yen-Chi Liu, Taoyuan City (TW)

(73) Assignee: Chunghwa Picture Tubes, LTD., Taoyuan City (TW)

(21) Appl. No.: 15/842,890

(22) Filed: Dec. 15, 2017

(30) Foreign Application Priority Data
Nov. 9, 2017 (CN) 201711095725.3

(51) Int. Cl. G02F 1/1343; G02F 1/1368; G02F 1/1362; G02F 1/1333

(52) U.S. Cl. CPC G02F 1/134309; G02F 1/1368; G02F 1/136227; G02F 1/13306; G02F 2001/134318; G02F 2201/123; G02F 1/133345

(57) ABSTRACT

A pixel structure including a thin-film transistor, a pixel electrode electrically connected to the thin-film transistor, a common electrode and an insulation layer located between the common electrode and the pixel electrode is provided. The pixel electrode has a plurality of first pixel branches. The common electrode has a plurality of first common branches. The first pixel branches and the first common branches are arranged alternately. An extending direction of the first pixel branches and an extending direction of the first common branches include a first acute angle.

### CROSS-REFERENCE TO RELATED APPLICATION

This application claims the priority benefit of China application serial no. 201711095725.3, filed on Nov. 9, 2017. The entirety of the above-mentioned patent application is hereby incorporated by reference herein and made a part of this specification.

### BACKGROUND OF THE INVENTION

### Field of the Invention

The invention relates to a pixel structure.

### Description of Related Art

Along with booming development of high level smart phones and tablet computers, performance of display screens thereon has attracted much attention. Generally, in addition to power saving, the display screens on the high level smart phones and the tablet computers also require to have optical properties of a wide viewing angle and low color shift, etc. In order to achieve the wide viewing angle and low color shift of the display screen to satisfy requirements of manufacturers of the high level smart phones and tablet computers, manufactures of the display screens develop a fringe-field switching (FFS) mode liquid crystal display screen. The FFS mode liquid crystal display screen includes a pixel array substrate, a counter substrate opposite to the pixel array substrate, and liquid crystal molecules between the pixel array substrate and the counter substrate. The pixel array substrate includes a pixel electrode, a common electrode and an insulation layer between the pixel electrode and the common electrode. When the pixel electrode and the common electrode have an enough voltage difference there between, a fringe electric field is generated between the pixel electrode and the common electrode, such that the liquid crystal molecules are horizontally rotated to display an image. However, in the FFS mode liquid crystal display screen, a motion mode of the liquid crystal molecules is horizontal rotation, which has a problem of too long response time.

### SUMMARY OF THE INVENTION

The invention is directed to a pixel structure, and a liquid display screen using such pixel structure has a short response time.

An embodiment of the invention provides a pixel structure including a thin-film transistor, a pixel electrode electrically connected to the thin-film transistor, a common electrode and an insulation layer located between the common electrode and the pixel electrode. The pixel electrode has a plurality of first pixel branches. The common electrode has a plurality of first common branches. The first pixel branches and the first common branches are arranged alternately. An extending direction of the first pixel branches and an extending direction of the first common branches include a first acute angle.

In the pixel structure of the embodiment of the invention, the first common branches define a plurality of first common slits, and each of the first pixel branches is partially overlapped with one corresponding first common slit and is partially overlapped with one corresponding first common branch.

In the pixel structure of the embodiment of the invention, the pixel electrode further has a plurality of second pixel branches, where an extending direction of the first pixel branches is different to an extending direction of the second pixel branches. The common electrode further has a plurality of second common branches, wherein an extending direction of the first common branches is opposite to an extending direction of the second common branches. The second pixel branches and the second common branches are arranged alternately, and the extending direction of the second pixel branches and the extending direction of the second common branches include a second acute angle.

In the pixel structure of the embodiment of the invention, the second common branches define a plurality of second common slits, and each of the second pixel branches is partially overlapped with one corresponding second common slit and partially overlapped with one corresponding second common branch.

In the pixel structure of the embodiment of the invention, the pixel electrode further has a plurality of pixel bending portions. The pixel bending portions are connected between the first pixel branches and the second pixel branches. The first pixel branches, the second pixel branches and the pixel bending portions define a plurality of pixel slits of the pixel electrode.

In the pixel structure of the embodiment of the invention, the common electrode further has a plurality of common bending portions. The common bending portions are connected between the first common branches and the second common branches.

In the pixel structure of the embodiment of the invention, the pixel electrode further has a plurality of pixel bending portions. The pixel bending portions are connected between the first pixel branches and the second pixel branches, and the pixel bending portions are overlapped with the common bending portions.

In the pixel structure of the embodiment of the invention, the common electrode further has a connection portion connected between the common bending portions.

In the pixel structure of the embodiment of the invention, an extending direction of the connection portion is perpendicular to an extending direction of the first common branches and an extending direction of the second common branches.

In the pixel structure of the embodiment of the invention, the connection portion, the common bending portions and the first common branches define a plurality of first common slits of the common electrode. The connection portion, the common bending portions and the second common branches define a plurality of second common slits of the common electrode. The first common slits and the second common slits are respectively located at two opposite sides of the connection portion.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a pixel structure according to an embodiment of the invention.

FIG. 2 is a cross-sectional view of the pixel structure according to an embodiment of the invention.

FIG. 3 is a top view of a pixel structure of a first comparative example.

FIG. 4 illustrates equipotential curves between a pixel electrode and a common electrode of the pixel structure of the embodiment of the invention.

FIG. 5 illustrates equipotential curves between a pixel electrode and a common electrode of a pixel structure of a first comparative example.

FIG. 6 is diagram illustrating brightness of a place where a part of a pixel structure of an embodiment of the invention is located.

FIG. 7 is diagram illustrating brightness of a place where a part of a pixel structure of a second comparative example is located.

FIG. 8 is a top view of a pixel structure of a third comparative example.

FIG. 9 is a diagram illustrating a driving voltage-transmittance curve of a liquid crystal display screen applying the pixel structure of an embodiment of the invention, and a driving voltage-transmittance curve of a liquid crystal display screen applying the pixel structure of the third comparative example.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

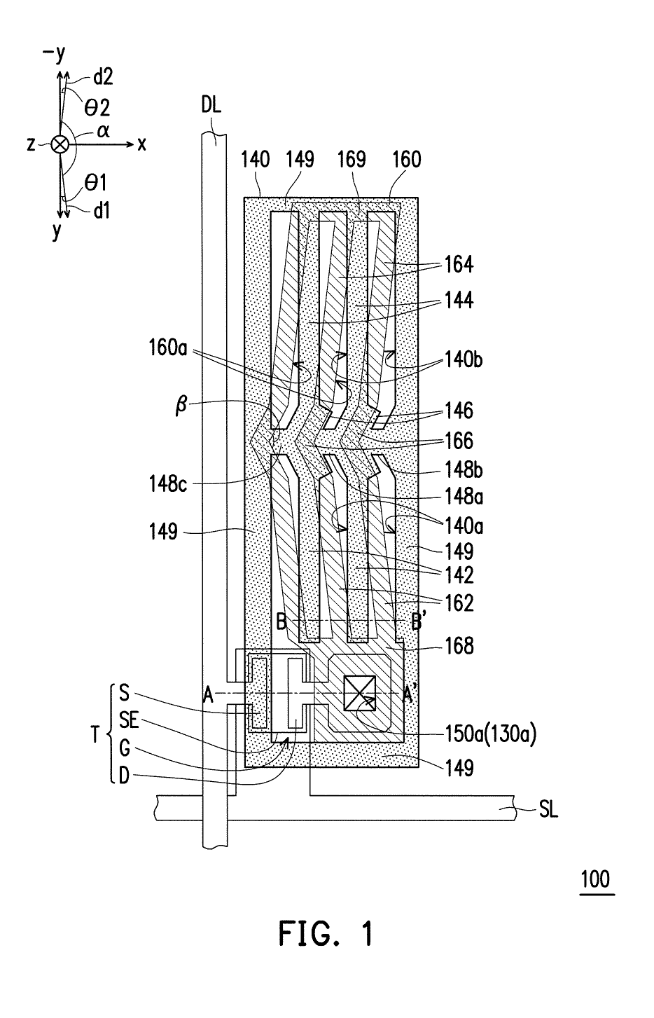

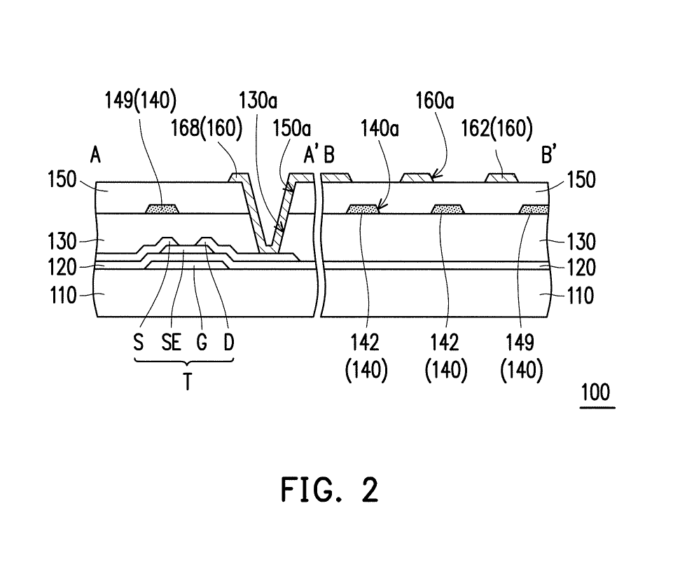

FIG. 1 is a top view of a pixel structure according to an embodiment of the invention. FIG. 2 is a cross-sectional view of the pixel structure according to an embodiment of the invention. Particularly, FIG. 2 corresponds to section lines A-A′ and B-B′ of FIG. 1. Referring to FIG. 1 and FIG. 2, the pixel structure 100 is disposed on the substrate 110. In the present embodiment, a material of the substrate 110 may be glass, quartz, organic polymer, an opaque/reflective material (for example, wafer, ceramic, or other suitable material), or other suitable material.

Referring to FIG. 1 and FIG. 2, the pixel structure 100 includes a thin-film transistor T. The thin-film transistor T includes a gate G, a semiconductor layer SE, a source S and a drain D. The source S and the drain D are respectively electrically connected to two different regions of the semiconductor layer SE. in the present embodiment, the gate G is disposed on the substrate 110, an insulation layer 120 covers the gate G, the semiconductor layer SE is disposed on the insulation layer 120, and the source S and the drain D respectively covers two different regions of the semiconductor layer SE. In the present embodiment, the gate G is located below the semiconductor layer SE, and the thin-film transistor T is, for example, a bottom gate thin-film transistor (TFT). However, the invention is not limited thereto, and in other embodiments, the thin-film transistor T may also be a top gate TFT, or other proper type of TFT.

In the present embodiment, the pixel structure 100 further includes a data line DL and a scan line SL intersected with each other. The data line DL is electrically connected to the source S of the thin-film transistor T. The scan line SL is electrically connected to the gate G of the thin-film transistor T. In the present embodiment, the source S may be a branch of the data line DL extending outward, and the gate G may be a branch of the scan line SL extending outward. However, the invention is not limited thereto, and in other embodiments, the source S may also be a part of the data line DL, and the gate G may also be a part of the scan line SL. Based on consideration of conductivity, the data line DL, the scan line SL, the gate G, the source S and the drain D are generally made of a metal material, though the invention is not limited thereto, and in other embodiments, the data line DL, the scan line SL, the gate G, the source S and/or the drain D may also be made of other conductive materials, such as alloys, nitrides of metal materials, oxides of metal materials, nitrogen oxides of metal materials, or a stacked layer of metal materials and other conductive materials.

The pixel structure 100 includes a common electrode 140. For example, in the present embodiment, the pixel structure 100 further includes an insulation layer 130, where the insulation layer 130 covers the thin-film transistor T and the insulation layer 120, and the common electrode 140 may be selectively disposed on the insulation layer 130, though the invention is not limited thereto.

The common electrode 140 has a plurality of first common branches 142. In the present embodiment, each of the first common branches 142 may be a straight branch. The first common branches 142 are parallel to each other and have a same extending direction y. In the present embodiment, the first common branches 142 may be selectively parallel to the data line DL, though the invention is not limited thereto. In the present embodiment, the common electrode 140 further has a plurality of second common branches 144. Each of the second common branches 144 may be a straight branch. The second common branches 144 are parallel to each other and have a same extending direction −y. The extending direction y of the first common branches 142 is opposite to the extending direction −y of the second common branches 144. In the present embodiment, the second common branches 144 may be selectively parallel to the data line DL, though the invention is not limited thereto.

In the present embodiment, the common electrode 140 further has a plurality of common bending portions 146. Each of the common bending portions 146 is connected between one corresponding first common branch 142 and one corresponding second common branch 144. For example, in the present embodiment, each of the common bending portions 146 may be a <-shape pattern, where two ends of the <-shape pattern are respectively connected to one corresponding first common branch 142 and one corresponding second common branch 144. Two straight line portions of the <-shape pattern (i.e. the common bending portion 146) are not parallel with the first common branches 142 and the second common branches 144.

In the present embodiment, the common electrode 140 further has a connection portion 148a. The connection portion 148a is connected between the common bending portions 146. In detail, the connection portion 148a is connected between a plurality of turning points of the common bending portions 146. In the present embodiment, the common electrode 140 further includes a peripheral portion 149. The peripheral portion 149 surrounds the first common branches 142, the second common branches 144, the common bending portions 146 and the connection portion 148a. One end of each of the second common branches 144 that is not connected to the common bending portion 146 may be connected to the peripheral portion 149. In the present embodiment, the common electrode 140 further includes a connection portion 148b and a connection portion 148c. The connection portion 148b is connected between the rightmost common bending portion 146 and the peripheral portion 149. The connection portion 148c is connected between the leftmost common bending portion 146 and the peripheral portion 149. The connection portion 148a, the connection portion 148b, the connection portion 148c and the common bending portions 146 form a branch-like conductive pattern, which may prevent a problem of line-breaking of the common electrode 140 during a manufacturing process. In the present embodiment, an extending direction x of the connection portion 148a, the connection portion 148b and the connection portion 148c may be perpendicular to the extending direction y of the first common branches 142 and the extending direction −y of the second common branches 144, though the invention is not limited thereto.

In the present embodiment, the connection portion 148a, the connection portion 148b, the connection portion 148c, the common bending portions 146, the first common branches 142 and the peripheral portion 149 define a plurality of first common slits 140a of the common electrode 140. The connection portion 148a, the connection portion 148b, the connection portion 148c, the common bending portions 146, the second common branches 144 and the peripheral portion 149 define a plurality of second common slits 140b of the common electrode 140. The first common slits 140a and the second common slits 140b are respectively connected to two opposite sides of the connection portion 148a, the connection portion 148b and the connection portion 148c. The first common branches 142, the second common branches 144, the common bending portions 146, the connection portion 148a, the connection portion 148b, the connection portion 148c and the peripheral portion 149 belong to a same conductive layer and are electrically connected to each other. In the present embodiment, the common electrode 140 is, for example, a transparent electrode layer, and a material of the transparent electrode layer includes metal oxides, such as indium tin oxide, indium zinc oxide, aluminum tin oxide, aluminum zinc oxide, indium germanium zinc oxide, or other proper oxide, or a stacked layer of at least two of the above materials. However, the invention is not limited thereto, and in other embodiments, the common electrode 140 may also be a reflective electrode layer, or a combination of the reflective electrode layer and the transparent electrode layer.

The pixel structure 100 includes an insulation layer 150. The insulation layer 150 is located between the common electrode 140 and a pixel electrode 160. For example, in the present embodiment, the insulation layer 150 may cover the common electrode 140, and the pixel electrode 160 may be disposed on the insulation layer 150. In other words, in the present embodiment, the pixel electrode 160 is located above the common electrode 140, and the common electrode 140 is located under the pixel electrode 160. However, the invention is not limited thereto, and in other embodiments, the common electrode 140 may be located above the pixel electrode 160, and the pixel electrode 160 is located under the common electrode 140. In the present embodiment, a material of the insulation layer 150 may be an inorganic material (for example, silicon oxide, silicon nitride, silicon oxynitride, or a stacked layer of at least two of the above materials), an organic material of a combination thereof.

The pixel structure 100 includes the pixel electrode 160. The pixel electrode 160 is electrically connected to the thin-film transistor T. For example, in the present embodiment, the insulation layer 150 and the insulation layer 130 respectively has a through hole 150a and a through hole 130a. The through hole 150a and the through hole 130a are connected through. The pixel electrode 160 may be extended to the through hole 150 and the through hole 130a to electrically connect the drain D of the thin-film transistor T. A potential difference between the common electrode 140 and the pixel electrode 160 is used for driving a display medium (for example, liquid crystal). A liquid crystal display screen applying the pixel structure 100 may be a fringe-field switching (FFS) mode liquid crystal display screen.

The pixel electrode 160 has a plurality of first pixel branches 162. In the present embodiment, each of the first pixel branches 162 may be a straight branch. The first pixel branches 162 are parallel with each other and have a same extending direction d1. The first pixel branches 162 and the first common branches 142 are arranged alternately, and the extending direction d1 of the first pixel branches 162 and the extending direction y of the first common branches 142 include a first acute angle θ1. For example, in the present embodiment, 1°≤θ1≤20°, though the invention is not limited thereto. In the present embodiment, the first pixel branches 162 are partially overlapped with the corresponding first common slits 140a and partially overlapped with the first common branches 142. Further, in a vertical projection direction z, a large part of the area of each of the first pixel branches 162 is located within the first common slit 140a, and a small part of the area of each of the first pixel branches 162 is located outside the first common slit 140a.

In the present embodiment, the pixel electrode 160 further has a plurality of second pixel branches 164. In the present embodiment, each of the second pixel branches 164 may be a straight branch. The second pixel branches 164 are parallel with each other and have a same extending direction d2. The extending direction d1 of the first pixel branches 162 and the extending direction d2 of the second pixel branches 164 are different. For example, in the present embodiment, the first pixel branches 162 may be extended toward a lower right direction of FIG. 1, and the second pixel branches 164 may be extended toward an upper right direction of FIG. 1, the extending direction d1 of the first pixel branches 162 and the extending direction d2 of the second pixel branches 164 may include an obtuse angle α, though the invention is not limited thereto. The second pixel branches 164 and the second common branches 144 are arranged alternately, and the extending direction d2 of the second pixel branches 164 and the extending direction −y of the second common branches 144 include a second acute angle θ2. For example, in the present embodiment, 1°≤θ2≤20°. The first acute angle θ1 and the second acute angle θ2 may be equivalent, though the invention is not limited thereto. In the present embodiment, the second pixel branches 164 are partially overlapped with the corresponding second common slits 140b and partially overlapped with the second common branches 144. Further, in the vertical projection direction z, a large part of the area of each of the second pixel branches 164 is located within the second common slit 140b, and a small part of the area of each of the second pixel branches 164 is located outside the second common slit 140b.

In the present embodiment, the pixel electrode 160 further has a plurality of pixel bending portions 166. Each of the pixel bending portions 166 is connected between one corresponding first pixel branch 162 and one corresponding second pixel branch 164. The pixel bending portions 166 are respectively overlapped with the common bending portions 146. For example, in the present embodiment, each of the pixel bending portions 166 may be a <-shape pattern, where two ends of the <-shape pattern are respectively connected to one corresponding first pixel branch 162 and one corresponding second pixel branch 164. Two straight line portions of the <-shape pattern (i.e. the pixel bending portion 166) are not parallel with the first pixel branches 162 and the second pixel branches 164. Further, in the present embodiment, the two straight line portions of the <-shape pattern (i.e. the pixel bending portion 166) may include an obtuse angle β, where the obtuse angle β may be smaller than the obtuse angle α, though the invention is not limited thereto.

In the present embodiment, the pixel electrode 160 further has a connection portion 168 and a connection portion 169 located outside the first pixel branches 162, the second pixel branches 164 and the pixel bending portions 166. One end of each of the first pixel branches 162 that is not connected to the pixel bending portion 166 is connected to the connection portion 168. One end of each of the second pixel branches 164 that is not connected to the pixel bending portion 166 is connected to the connection portion 169. The first pixel branches 162, the second pixel branches 164, the pixel bending portions 166, the connection portion 168 and the connection portion 169 define a plurality of pixel slits 160a of the pixel electrode 160. In the present embodiment, in the vertical projection direction z, a large part of the area of each of the first common branches 142 is located within the pixel slit 160a, and a small part of the area of each of the first common branches 142 is located outside the pixel slit 160a; in the vertical projection direction z, a large part of the area of each of the second common branches 144 is located within the pixel slit 160a, and a small part of the area of each of the second common branches 144 is located outside the pixel slit 160a. The first pixel branches 162, the second pixel branches 164, the pixel bending portions 166, the connection portion 168 and the connection portion 169 belong to a same conductive layer and are electrically connected to each other. In the present embodiment, the pixel electrode 160 is, for example, a transparent electrode layer, and a material of the transparent electrode layer includes metal oxides, such as indium tin oxide, indium zinc oxide, aluminum tin oxide, aluminum zinc oxide, indium germanium zinc oxide, or other proper oxide, or a stacked layer of at least two of the above materials. However, the invention is not limited thereto, and in other embodiments, the pixel electrode 160 may also be a reflective electrode layer, or a combination of the reflective electrode layer and the transparent electrode layer.

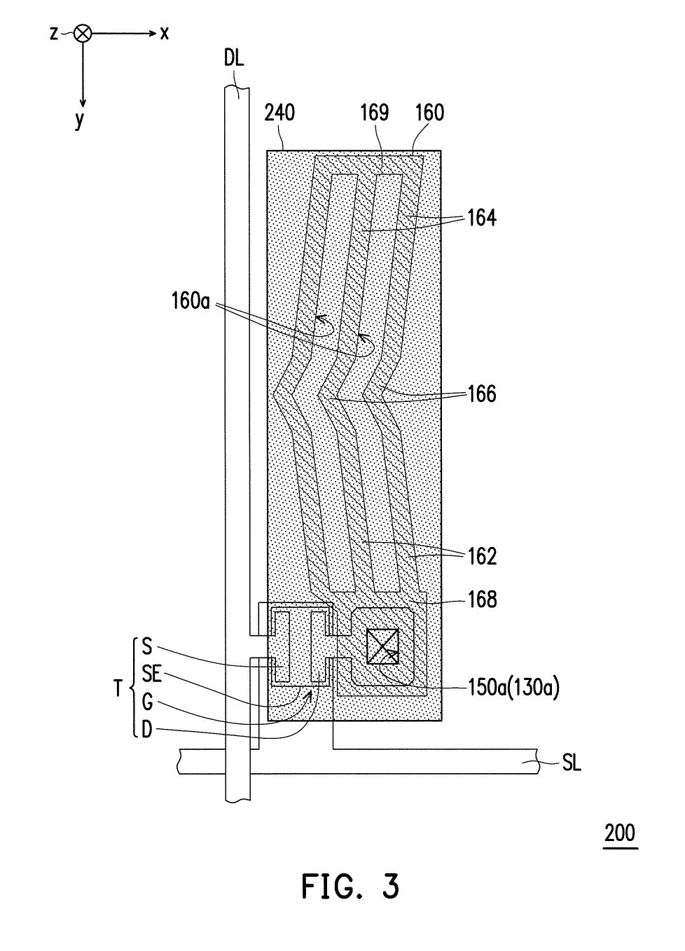

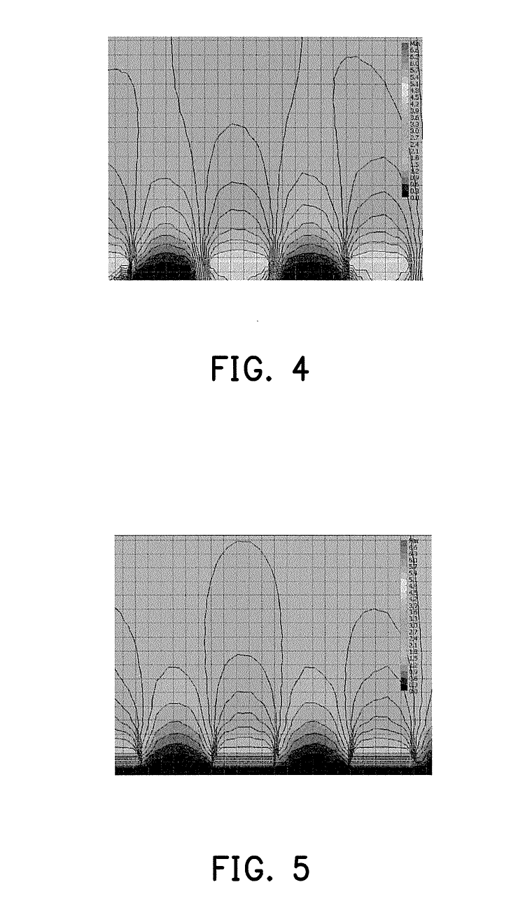

FIG. 3 is a top view of a pixel structure of a first comparative example. Referring to FIG. 1 and FIG. 3, the pixel structure 200 of the first comparative example is similar to the pixel structure 100 of the above embodiment, though the common electrode 240 of the pixel structure 200 of the first comparative example is a whole plane like and does not have slits. FIG. 4 illustrates equipotential curves between the pixel electrode 160 and the common electrode 140 of the pixel structure 100 according to an embodiment of the invention. FIG. 5 illustrates equipotential curves between the pixel electrode 160 and the common electrode 240 of the pixel structure 200 according to the first comparative example. Referring to FIG. 1, in the present embodiment, the first pixel branches 162 and the first common branches 142 are arranged alternately, and the extending direction d1 of the first pixel branches 162 and the extending direction y of the first common branches 142 include the first acute angle θ1. Namely, the first common slits 140a of the common electrode 140 substantially have straight bar shapes, and are overlapped with the inclined first pixel branches 162. Referring to FIG. 4 and FIG. 5, compared to the pixel structure 200 of the first comparative example, the pixel structure 100 of the present embodiment makes a potential curve between the first pixel branches 162 and the common electrode 140 to present a more upward (i.e. a direction opposite to the vertical projection direction z of FIG. 1 and FIG. 3) distribution, so as to shorten a response time of the liquid crystal display screen applying the pixel structure 100. Similarly, in the present embodiment, the second pixel branches 164 and the second common branches 144 are arranged alternately, and the extending direction d2 of the second pixel branches 164 and the extending direction −y of the second common branches 144 include the second acute angle θ2. Namely, the second common slits 140b of the common electrode 140 substantially have straight bar shapes, and are overlapped with the inclined second pixel branches 164. Referring to FIG. 4 and FIG. 5, compared to the pixel structure 200 of the first comparative example, the pixel structure 100 of the present embodiment makes a potential curve between the second pixel branches 164 and the common electrode 140 to present a more upward distribution, so as to shorten the response time. For example, a response time of a liquid crystal display screen applying the pixel structure 200 of the first comparative example is 38.14 ms, and a response time of a liquid crystal display screen applying the pixel structure 100 of the present embodiment is 35.65 ms, and the response time of the liquid crystal display screen applying the pixel structure 100 of the present embodiment is shortened by 7%.

Moreover, in the present embodiment, the extending direction d1 of the first pixel branches 162 is different to the extending direction d2 of the second pixel branches 164, so that the liquid crystals respectively located on the first pixel branches 162 and the second pixel branches 164 are arranged in different directions to form a plurality of domains. In this way, the liquid crystal display screen applying the pixel structure 100 may not only shorten the response time, but may also keep characteristics of wide viewing angle and low color shift.

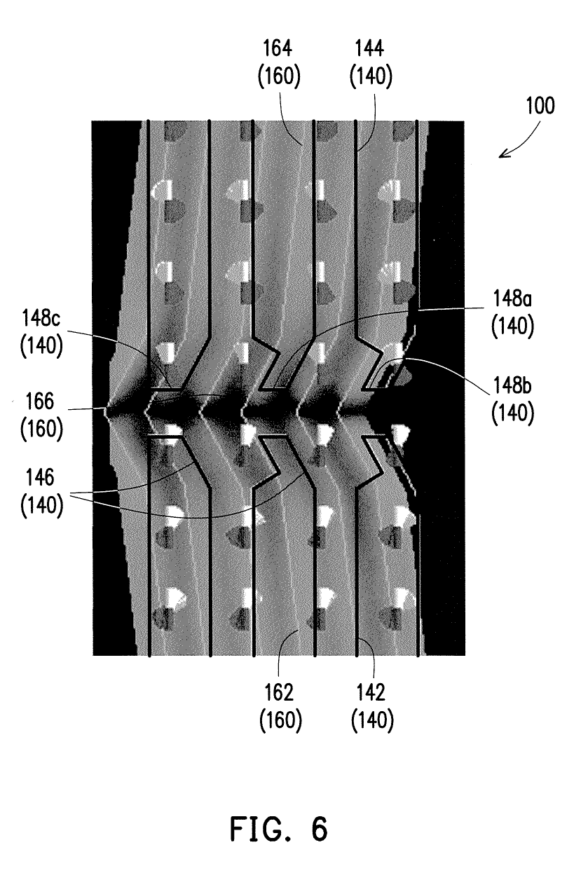

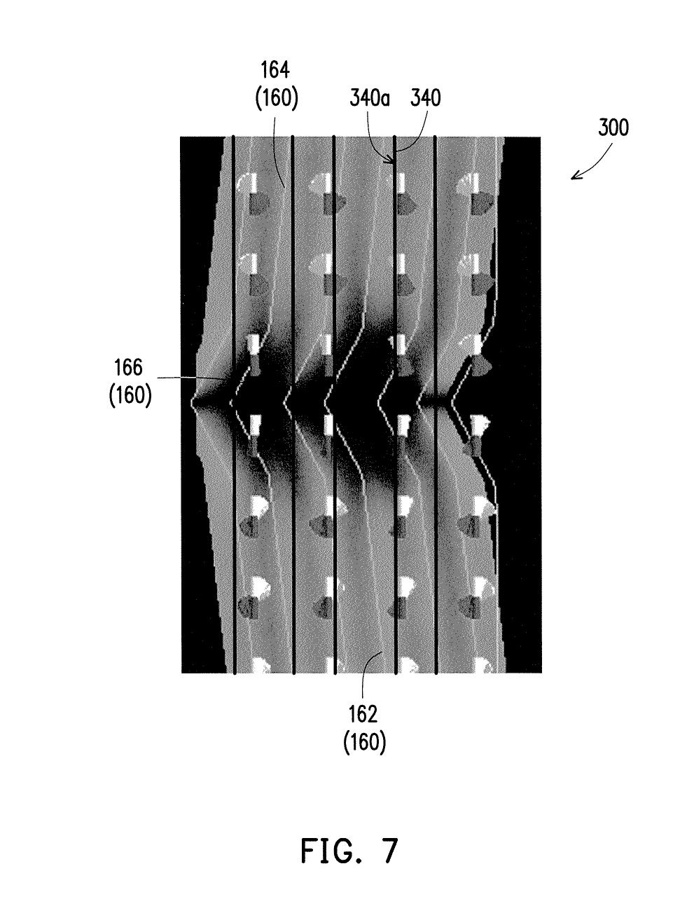

FIG. 6 is diagram illustrating brightness of a place where a part of the pixel structure 100 is located according to an embodiment of the invention. FIG. 7 is diagram illustrating brightness of a place where a part of a pixel structure 300 of a second comparative example is located according to an embodiment of the invention. The pixel structure 300 of the second comparative example is similar to the pixel structure 100 of the present embodiment, though the common electrode 340 of the pixel structure 300 of the second comparative example does not have the common bending portions 146, the connection portion 148a, the connection portion 148b and the connection portion 148c of the common electrode 140 of the present embedment. Namely, as shown in FIG. 7, the common electrode 340 of the second comparative example has a plurality of straight bar shape slits 340a, and each of the straight bar shape slits 340a is overlapped with one corresponding first pixel branch 162 and one corresponding second pixel branch 164. Referring to FIG. 7, in the second comparative example, a liquid crystal arrangement at a region R near the pixel bending portions 166 is poor, and an area formed by disclination lines is large. Referring to FIG. 6, in the present embodiment, in the branch-like conductive pattern formed by the connection portion 148a, the connection portion 148b, the connection portion 148c and the common bending portions 146, the liquid crystal arrangement at the region R near the pixel bending portions 166 of the pixel electrode 160 is good, and the area formed by disclination lines is small. Therefore, the liquid crystal display screen applying the pixel structure 100 of the present embodiment has good transmittance.

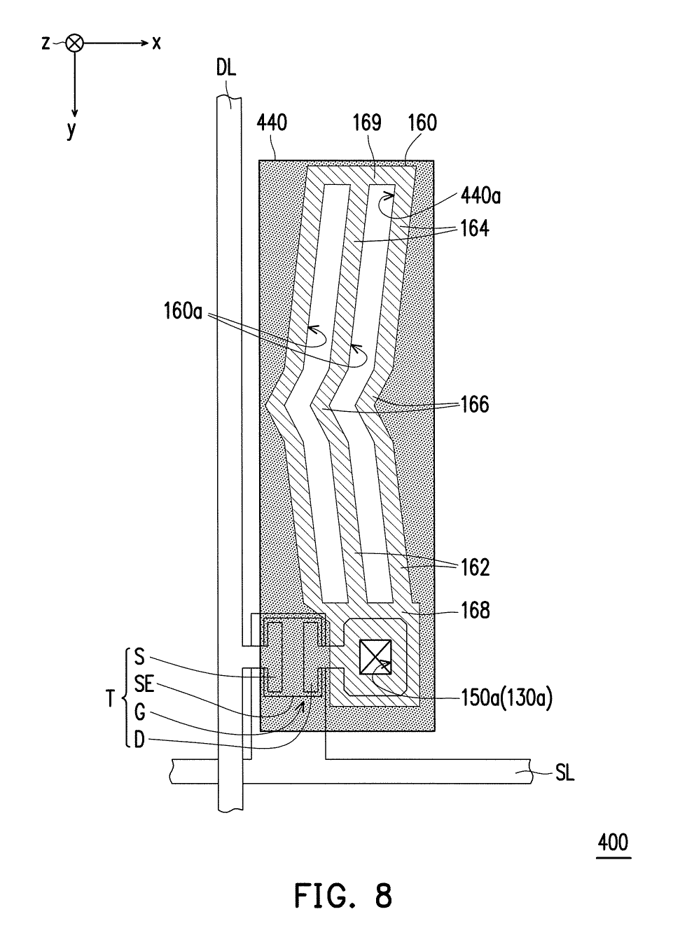

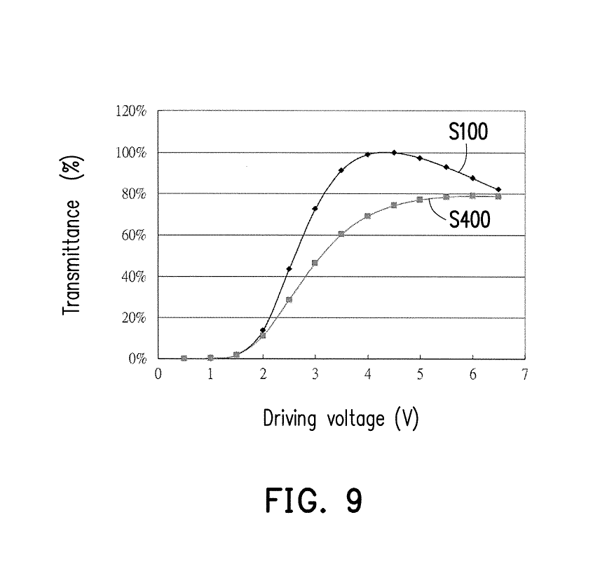

FIG. 8 is a top view of a pixel structure of a third comparative example. Referring to FIG. 1 and FIG. 8, the pixel structure 400 of the third comparative example is similar to the pixel structure 100 of the present embodiment, though the slits 440a of the common electrode 440 of the pixel structure 400 of the third comparative example do not present straight bar shapes, and the slits 440a of the common electrode 440 of the third comparative example are aligned with the pixel slits 160a. FIG. 9 is a diagram illustrating a driving voltage-transmittance curve S100 of a liquid crystal display screen applying the pixel structure 100 of the embodiment of the invention, and a driving voltage-transmittance curve S400 of a liquid crystal display screen applying the pixel structure 400 of the third comparative example. According to FIG. 9, it is known that the transmittance of the liquid crystal display screen applying the pixel structure 100 of the present embodiment under various driving voltage is obviously higher than that of the liquid crystal display screen applying the pixel structure 400 of the third comparative example.

In summary, the pixel structure of the embodiment of the invention includes a thin-film transistor, a pixel electrode electrically connected to the thin-film transistor, a common electrode and an insulation layer located between the common electrode and the pixel electrode. The pixel electrode has a plurality of first pixel branches. The common electrode has a plurality of first common branches. The first pixel branches and the first common branches are arranged alternately, and an extending direction of the first pixel branches and an extending direction of the first common branches include a first acute angle. In this way, the equipotential curve between the first pixel branches and the common electrode presents an upward distribution, so as to shorten the response time of the liquid crystal display screen applying the pixel structure of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A pixel structure, comprising:
a thin-film transistor;
a pixel electrode, electrically connected to the thin-film transistor, and having a plurality of first pixel branches;
a common electrode, having a plurality of first common branches, wherein the first pixel branches and the first common branches are arranged alternately, and an extending direction of the first pixel branches and an extending direction of the first common branches include a first acute angle; and
an insulation layer, located between the common electrode and the pixel electrode.

2. The pixel structure as claimed in claim 1, wherein the first common branches define a plurality of first common slits, and each of the first pixel branches is partially overlapped with one corresponding first common slit and is partially overlapped with one corresponding first common branch.

3. The pixel structure as claimed in claim 1, wherein the pixel electrode further has a plurality of second pixel branches, wherein an extending direction of the first pixel branches is different to an extending direction of the second pixel branches; the common electrode further has a plurality of second common branches, wherein an extending direction of the first common branches is opposite to an extending direction of the second common branches, the second pixel branches and the second common branches are arranged alternately, and the extending direction of the second pixel branches and the extending direction of the second common branches include a second acute angle.

4. The pixel structure as claimed in claim 3, wherein the second common branches define a plurality of second common slits, and each of the second pixel branches is partially overlapped with one corresponding second common slit and partially overlapped with one corresponding second common branch.

5. The pixel structure as claimed in claim 3, wherein the pixel electrode further has a plurality of pixel bending portions, the pixel bending portions are connected between the first pixel branches and the second pixel branches, wherein the first pixel branches, the second pixel branches and the pixel bending portions define a plurality of pixel slits of the pixel electrode.

6. The pixel structure as claimed in claim 3, wherein the common electrode further has a plurality of common bending portions connected between the first common branches and the second common branches.

7. The pixel structure as claimed in claim 6, wherein the pixel electrode further has a plurality of pixel bending portions, the pixel bending portions are connected between the first pixel branches and the second pixel branches, and the pixel bending portions are overlapped with the common bending portions.

8. The pixel structure as claimed in claim 6, wherein the common electrode further has a connection portion connected between the common bending portions.

9. The pixel structure as claimed in claim 8, wherein an extending direction of the connection portion is perpendicular to an extending direction of the first common branches and an extending direction of the second common branches.

10. The pixel structure as claimed in claim 8, wherein the connection portion, the common bending portions and the first common branches define a plurality of first common slits of the common electrode, the connection portion, the common bending portions and the second common branches define a plurality of second common slits of the common electrode, and the first common slits and the second common slits are respectively located at two opposite sides of the connection portion.
